(19) United States
(12) Patent Application Publication
(10) Pub. No.: US 2025/0217018 A1
(43) Pub. Date: Jul. 3, 2025

(54) FOLDABLE ELECTRONIC DEVICE AND METHOD FOR OPERATING FOLDABLE ELECTRONIC DEVICE

(71) Applicant: Samsung Electronics Co., Ltd., Suwon-si (KR)

(72) Inventors: Chaekyung LEE, Suwon-si (KR); Jiwon KIM, Suwon-si (KR); Seungyong LEE, Suwon-si (KR)

(21) Appl. No.: 19/084,191

(22) Filed: Mar. 19, 2025

Related U.S. Application Data
(63) Continuation of application No. PCT/KR2023/014400, filed on Sep. 21, 2023.

(30) Foreign Application Priority Data
Sep. 21, 2022 (KR) 10-2022-0119343
Oct. 17, 2022 (KR) 10-2022-0133474

(51) Int. Cl. G06F 3/04842; G06F 1/16; G06F 3/04845; G06F 3/04886

(52) U.S. Cl. CPC G06F 3/04842; G06F 1/1652; G06F 1/1677; G06F 3/04845; G06F 3/04886; G06F 2203/04803

(57) ABSTRACT

A foldable electronic device is provided. The foldable electronic device includes a first housing, a second housing which is connected to the first housing so as to be foldable with reference to a designated axis, and changes an overall shape of the electronic device, a sensor configured to detect a folding state of the electronic device, a display including a flexible display which has at least partial area foldable with reference to the designated axis, and is divided into a first area and a second area with reference to the designated axis, memory storing one or more computer programs, and one or more processors communicatively coupled to the memory, wherein the one or more computer programs include computer-executable instructions that, when executed by the one or more processors individually or collectively, cause the electronic device to detect the folding state of the electronic device by using the sensor, determine, on the basis of the folding state, an area in which an input for displaying a quick panel on the display is to be received and an area in which the quick panel is to be displayed, determine a configuration of the quick panel by determining, based on a running application, a component to be included in the quick panel, and display the quick panel having the determined configuration in the determined area in response to receiving, in the determined area, the input for displaying the quick panel.

### CROSS-REFERENCE TO RELATED APPLICATION(S)

This application is a continuation application, claiming priority under § 365(c), of an International application No. PCT/KR2023/014400, filed on Sep. 21, 2023, which is based on and claims the benefit of a Korean patent application number 10-2022-0119343, filed on Sep. 21, 2022, in the Korean Intellectual Property Office, and of a Korean patent application number 10-2022-0133474, filed on Oct. 17, 2022, in the Korean Intellectual Property Office, the disclosure of each of which is incorporated by reference herein in its entirety.

### BACKGROUND

### 1. Field

The disclosure relates to a foldable electronic device and a method for operating a foldable electronic device.

### 2. Description of Related Art

An electronic device such as a bar-type, foldable-type, rollable-type, or sliding-type smartphone or tablet personal computer (PC) has been increasingly used, and the electronic device provides various functions.

A foldable electronic device may operate in states such as a fully unfolded state, a state of being folded at about 90 degrees, or a fully folded state according to folding or unfolding of a first housing and a second housing with reference to a hinge.

The electronic device may display, on a display, a quick panel including a component (e.g., wireless-fidelity (Wi-Fi) activation, cellular data activation, brightness adjustment, or sound adjustment) enabling simple configuration of the electronic device by a designated input of a user.

The above information is presented as background information only to assist with an understanding of the disclosure. No determination has been made, and no assertion is made, as to whether any of the above might be applicable as prior art with regard to the disclosure.

### SUMMARY

The foldable electronic device may display different screens in an upper area and a lower area of a display while being folded at about 90 degrees. For example, when a running application is a camera application, the foldable electronic device may display a camera screen in the upper area of the display area, and display a screen for controlling the camera application in the lower area thereof. In this case, the lower area of the display may fail to display much information due to a problem of a screen size.

There may be a case where, for image-capturing by a camera, a user uses the foldable electronic device by mounting the same in a state where the foldable electronic device is being folded at about 90 degrees. In the case where the user captures an image while the electronic device is folded at about 90 degrees and mounted, when the user touches the upper area of the display to control the electronic device, a blurry image may be captured due to the shaking of the electronic device.

Aspects of the disclosure are to address at least the above-mentioned problems and/or disadvantages and to provide at least the advantages described below. Accordingly, an aspect of the disclosure is to provide a technology of when an electronic device is folded at about 90 degrees and mounted, displaying a user interface (UI) (e.g., a quick panel, a notification area, and application control) for control of the electronic device in a lower area of a display, and determining and displaying a component of a quick panel related to a running application.

Additional aspects will be set forth in part in the description which follows and, in part, will be apparent from the description, or may be learned by practice of the presented embodiments.

In accordance with an aspect of the disclosure, an electronic device is provided. The electronic device includes a first housing, a second housing which is connected to the first housing so as to be foldable with reference to a designated axis, and changes an overall shape of the electronic device, a sensor configured to detect a folding state of the electronic device, a display including a flexible display which has at least partial area foldable with reference to the designated axis, and is divided into a first area and a second area with reference to the designated axis, memory storing one or more computer programs, and one or more processors communicatively coupled to the memory, wherein the one or more computer programs include computer-executable instructions that, when executed by the one or more processors individually or collectively, cause the electronic device to detect the folding state of the electronic device by using the sensor, determine, based on the folding state, an area in which an input for displaying a quick panel on the display is to be received and an area in which the quick panel is to be displayed, determine a configuration of the quick panel by determining, based on a running application, a component to be included in the quick panel, and display the quick panel having the determined configuration in the determined area in response to receiving, in the determined area, the input for displaying the quick panel.

In accordance with another aspect of the disclosure, a method for operating an electronic device which includes a flexible display and is foldable is provided. The method includes detecting a folding state of the electronic device by using a sensor, determining, based on the folding state of the electronic device, an area in which an input for displaying a quick panel on the display is to be received and an area in which the quick panel is to be displayed, determining a configuration of the quick panel by determining, based on a running application, a component to be included in the quick panel, and displaying the quick panel having the determined configuration in the determined area in response to receiving, in the determined area, the input for displaying the quick panel.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include detecting a folding state of the electronic device by using a sensor, determining, based on the folding state of the electronic device, an area in which an input for displaying a quick panel on the display is to be received and an area in which the quick panel is to be displayed, determining a configuration of the quick panel by determining, based on a running application, a component to be included in the quick panel, and displaying the quick panel having the determined configuration in the determined area in response to receiving, in the determined area, the input for displaying the quick panel.

For example, an electronic device determines an input area for displaying a quick panel according to a mounting state of the electronic device.

For example, an electronic device determines a display area of a quick panel and/or a display area of a notification according to a mounting state of the electronic device.

For example, an electronic device provides a user environment of controlling the electronic device, without interruption to the user of an application.

For example, an electronic device displays essential information in a narrow display area by configuring different components of a quick panel, based on an application in use.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2A is a front view illustrating an electronic device according to an embodiment of the disclosure;

FIG. 2B is a perspective view illustrating a first folding state of an electronic device according to an embodiment of the disclosure;

FIG. 2C is a perspective view illustrating a second folding state of an electronic device according to an embodiment of the disclosure;

FIG. 2D is a perspective view illustrating a third folding state of an electronic device according to an embodiment of the disclosure;

FIG. 2E is a block diagram illustrating an electronic device according to an embodiment of the disclosure;

FIG. 3 is a flow chart illustrating a method for configuring and displaying, based on a running application and a folding state of an electronic device, a quick panel by a processor according to an embodiment of the disclosure;

FIG. 4A illustrates an example of a screen configured and displayed by a processor in a second folding state of an electronic device according to an embodiment of the disclosure;

FIG. 4B illustrates an example of a screen configured and displayed by a processor in a second folding state of an electronic device according to an embodiment of the disclosure;

FIG. 5 illustrates an example of a screen configured and displayed by a processor in a second folding state of an electronic device according to an embodiment of the disclosure; and

FIG. 6 illustrates an example of a screen configured and displayed by a processor in a second folding state of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

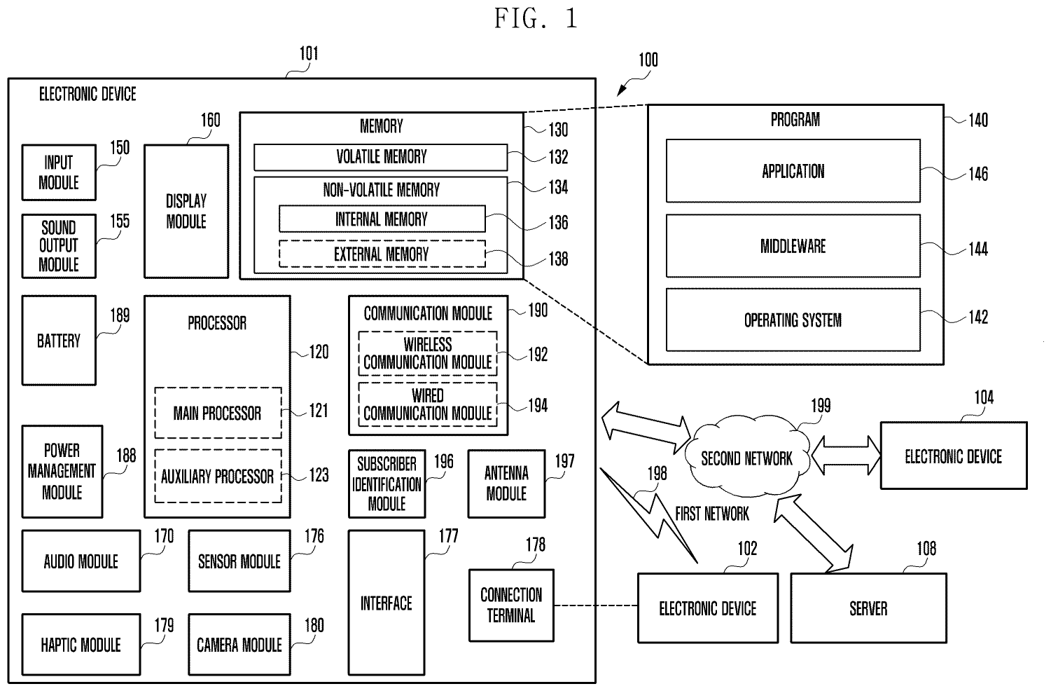

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). In an embodiment, the electronic device 101 may communicate with the electronic device 104 via the server 108. According to another embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. In an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to another embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to another embodiment, the auxiliary processor 123 (e.g., an image signal processor or a communication processor) may be implemented as part of another component (e.g., the camera module 180 or the communication module 190) functionally related to the auxiliary processor 123. According to another embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. In an embodiment, the sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to another embodiment, the display module 160 may include a touch sensor adapted to detect a touch, or a pressure sensor adapted to measure the intensity of force incurred by the touch.

The audio module 170 may convert a sound into an electrical signal and vice versa. According to another embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. In an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to another embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. In an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to another embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth-generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. In an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to another embodiment, another component (e.g., a radio frequency integrated circuit (RFIC)) other than the radiating element may be additionally formed as part of the antenna module 197. According to various embodiments, the antenna module 197 may form a mmWave antenna module. According to yet another embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

Commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may, for example, provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

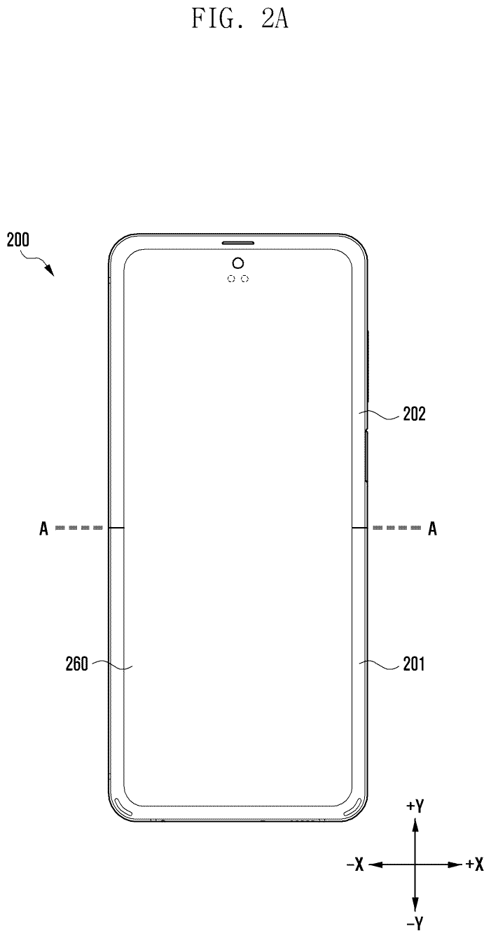

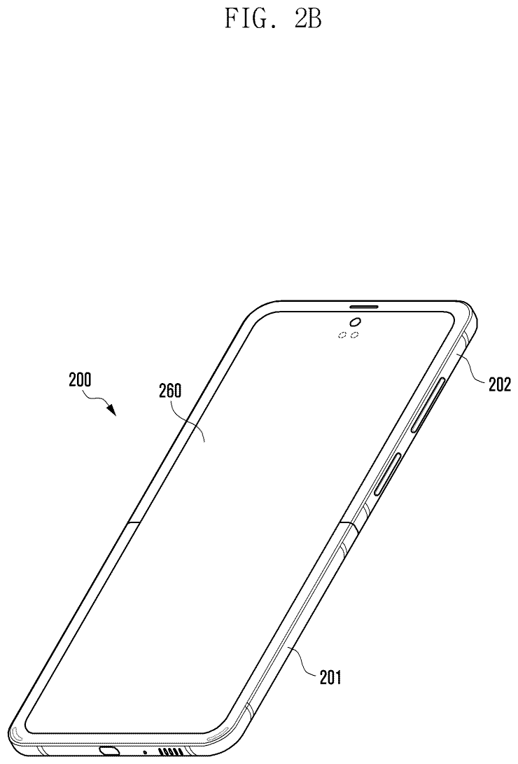

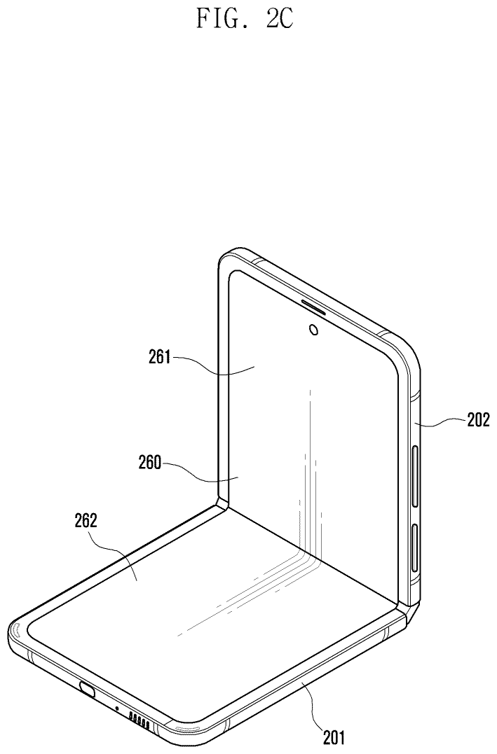

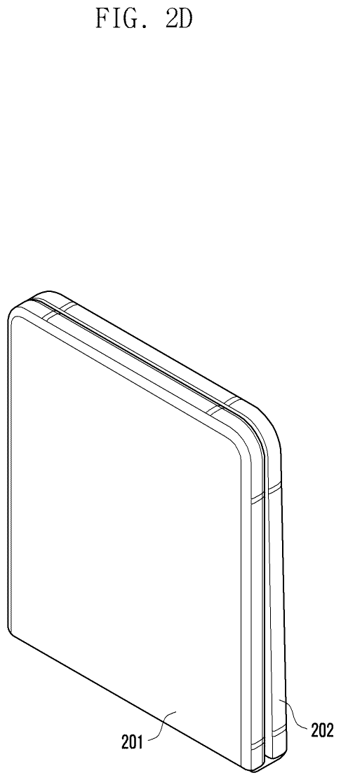

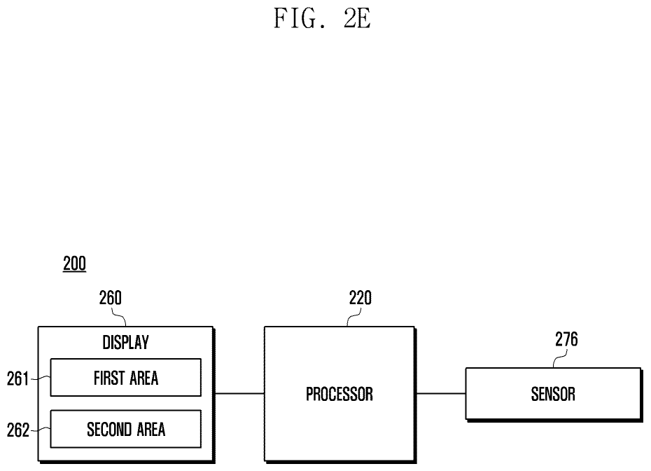

FIG. 2A is a front view illustrating an electronic device according to an embodiment of the disclosure.

FIG. 2B is a perspective view illustrating a first folding state of an electronic device according to an embodiment of the disclosure.

FIG. 2C is a perspective view illustrating a second folding state of an electronic device according to an embodiment of the disclosure.

FIG. 2D is a perspective view illustrating a third folding state of an electronic device according to an embodiment of the disclosure.

For example, a first folding state may indicate a folding state of the electronic device when an angle value between a first housing 201 and a second housing 202 is in a first angle range (e.g., 180 degrees to 120 degrees). For example, a second folding state may indicate a folding state of the electronic device when an angle value between the first housing 201 and the second housing 202 is in a second angle range (e.g., 120 degrees to 60 degrees). In another example, a third folding state may indicate a folding state of the electronic device when an angle value between the first housing 201 and the second housing 202 is in a third angle range (e.g., 60 degrees to 0 degrees).

The angle range and/or the angle value described as an example is one example, and may be changed according to various embodiments and applied.

According to various embodiments, an electronic device 200 illustrated in FIGS. 2A, 2B, 2C, and 2D may be an embodiment of the electronic device 101 described with reference to FIG. 1. The electronic device 200 described below may include at least a part of the elements illustrated in FIG. 1.

According to some embodiments, the electronic device 200 may include the first housing 201 and the second housing 202. The first housing 201 and the second housing 202 may be foldably connected. For example, as shown in FIG. 2C, the entire shape of the electronic device 200 may be changed upon the folding of the first housing 201 and the second housing 202. In one embodiment, the first housing 201 and the second housing 202 may be folded with reference to an axis (e.g., A-A axis of FIG. 2A) in parallel to a width direction (e.g., an X-axis direction of FIG. 2A) of the electronic device 200. In another example, the first housing 201 and the second housing 202 may be also folded with reference to an axis in parallel to a length direction (e.g., a Y-axis direction of FIG. 2A) of the electronic device 200.

According to other embodiments, the electronic device 200 may include a display module 260 (e.g., the display module 160 of FIG. 1) supported by the first housing 201 and the second housing 202. The display module 260 may include all of various devices capable of displaying visual information. In an embodiment, at least a part of the display module 260 may be folded by the folding of the first housing 201 and the second housing 202. The folding of the display module 260 may include all of a change of being fully folded and a change of being bent while maintaining a predetermined curvature.

According to various embodiments, the display module 260 may be a flexible display having at least partial area that can be folded. A substrate of the display module 260 may be formed of a flexible material. For example, the substrate of the display module 260 may be formed of a polymeric material such as polyethylene terephthalate (PET) and polyimide (PI) or glass processed in a very thin thickness.

Referring to FIG. 2D, in the state in which the electronic device 200 is folded, the first housing 201 and the second housing 202 may be substantially face each other. The electronic device 200 is folded, the portability of the electronic device 200 can be improved, and thus the electronic device 200 including a large-scale display module 260 can be manufactured in a compact manner. In addition, in the folded state as in FIG. 2C, a part of the display module 260, exposed to the outside, is reduced, and thus a damage to or contamination of the display module 260 can be prevented.

FIG. 2E is a block diagram illustrating an electronic device 200 according to an embodiment of the disclosure.

Referring to FIG. 2E, an electronic device 200 (e.g., the electronic device 101 of FIG. 1) may include a processor 220 (e.g., the processor 120 of FIG. 1), a display 260 (e.g., the display 160 of FIG. 1), and/or a sensor 276 (e.g., the sensor module 176 of FIG. 1). The elements included in FIG. 2E are for some of the elements included in FIG. 2E, and the electronic device 200 may include various other elements as shown in FIG. 1.

The display 260 according to various embodiments may be a flexible display 260 having at least partial area which can be folded. The display 260 according to one embodiment may be divided into a first area 261 and/or a second area 262 with reference to a foldable part.

For example, the first area 261 may indicate an upper area of the display 260 with reference to an axis (e.g., A-A axis of FIG. 2A) in parallel to a width direction (e.g., an X-axis direction of FIG. 2A) of the electronic device 200.

The second area 262 may indicate a lower area of the display 260 with reference to an axis (e.g., A-A axis of FIG. 2A) in parallel to a width direction (e.g., an X-axis direction of FIG. 2A) of the electronic device 200.

The sensor 276 according to various embodiments may measure the degree of folding of the electronic device 200. For example, the sensor 276 may include a magnetic sensor (e.g., a hall IC).

The magnetic sensor (e.g., hall IC) may acquire (or measure) sensing information for detecting an unfolded state (or a folded state) of the electronic device 200, and transfer the same to the processor 220.

In an embodiment, the processor 220 may identify, based on whether a sensor value acquired through the sensor 276 is included in a designated value range and an angle value between the first housing 201 and the second housing 202 is within a designated angle, the folding state of the electronic device 200.

The folding state of the electronic device 200 according to an embodiment may be divided into a first folding state, a second folding state, and/or a third folding state. For example, the first folding state may indicate the folding state of the electronic device 200 when an angle value between the first housing 201 and the second housing 202 is in a first angle range (e.g., 180 degrees to 120 degrees). In another example, the second folding state may indicate the folding state of the electronic device 200 when an angle value between the first housing 201 and the second housing 202 is in a second angle range (e.g., 120 degrees to 60 degrees). For example, the third folding state may indicate the folding state of the electronic device 200 when an angle value between the first housing 201 and the second housing 202 is in a third angle range (e.g., 60 degrees to 0 degrees).

The electronic device 200 may acquire a value of the sensor 276 corresponding to the angle value between the first housing 201 and the second housing 202.

The sensor value and the sensor value range described as examples are one example, and may be changed according to various embodiments and applied.

A sensor value acquired through the sensor 276 in the first folding state by the electronic device 200 may be a value of a first range (e.g., 0 to 0.3) and/or a first value (e.g., 0). A sensor value acquired through the sensor 276 in the second folding state by the electronic device 200 may be a value of a second range (e.g., 0.3 to 0.6) and/or a second value (e.g., 0.5). A sensor value acquired through the sensor 276 in the third folding state by the electronic device 200 may be, for example, a value of a third range (e.g., 0.6 to 1) and/or a third value (e.g., 1). In an embodiment, the processor 220 may identify whether the sensor value acquired through the sensor 276 is the value of the first range and/or the first value. When the sensor value acquired through the sensor 276 is the value of the first range and/or the first value, the processor 220 may identify whether the angle value between the first housing 201 and the second housing 202 is in a first angle range (e.g., 180 degrees to 120 degrees). In an embodiment, when the angle value between the first housing 201 and the second housing 202 is in the first angle range (e.g., 180 degrees to 120 degrees), the processor 220 may determine the state of the electronic device 200 to be the first folding state.

In an embodiment, the processor 220 may identify whether the sensor value acquired through the sensor 276 is the value of the second range and/or the second value. When the sensor value acquired through the sensor 276 is the value of the second range and/or the second value, the processor 220 may identify whether the angle value between the first housing 201 and the second housing 202 is in a second angle range (e.g., 120 degrees to 60 degrees). In an embodiment, when the angle value between the first housing 201 and the second housing 202 is in the second angle range (e.g., 120 degrees to 60 degrees), the processor 220 may determine the state of the electronic device 200 to be the second folding state.

The processor 220 may identify whether the sensor value acquired through the sensor 276 is the value of the third range and/or the third value. When the sensor value acquired through the sensor 276 is the value of the third range and/or the third value, the processor 220 may identify whether the angle value between the first housing 201 and the second housing 202 is in a third angle range (e.g., 60 degrees to 0 degrees). In an embodiment, when the angle value between the first housing 201 and the second housing 202 is in the third angle range (e.g., 60 degrees to 0 degrees), the processor 220 may determine the state of the electronic device 200 to be the third folding state.

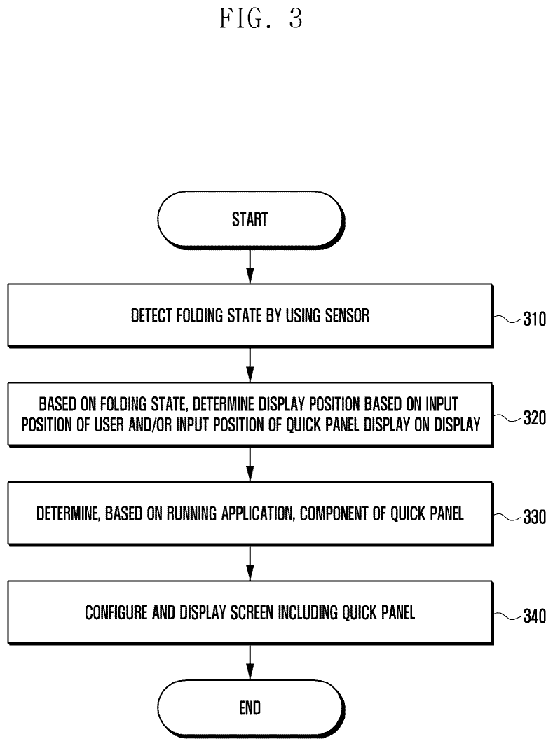

FIG. 3 is a flow chart illustrating a method for configuring and displaying, based on a running application and a folding state of an electronic device (e.g., the electronic device 200 of FIG. 2E), a quick panel by a processor (e.g., the processor 220 of FIG. 2E) according to an embodiment of the disclosure.

Referring to FIG. 3, in operation 310, the processor 220 according to various embodiments may detect a folding state of the electronic device 200 by using a sensor (e.g., the sensor 276 of FIG. 2E).

The processor 220 may identify, based on whether the sensor value acquired through the sensor 276 is included in a designate value range and an angle value between a first housing (e.g., the first housing 201 of FIG. 2A) and a second housing (e.g., the second housing 202 of FIG. 2A) is in a designated angle range, the folding state of the electronic device 200.

The folding state of the electronic device 200 according to an embodiment may be divided into a first folding state, a second folding state, and/or a third folding state. For example, the first folding state may indicate a folding state of the electronic device 200 when an angle value between the first housing 201 and the second housing 202 is in a first angle range (e.g., 180 degrees to 120 degrees). For example, the second folding state may indicate a folding state of the electronic device 200 when the angle value between the first housing 201 and the second housing 202 is in a second angle range (e.g., 120 degrees to 60 degrees). In another example, the third folding state may indicate a folding state of the electronic device 200 when the angle value between the first housing 201 and the second housing 202 is in a third angle range (e.g., 60 degrees to 0 degrees).

The angle range and/or the angle value described as an example is one example, and may be changed according to various embodiments and applied.

In an embodiment, the electronic device 200 may acquire a value of the sensor 276 corresponding to the angle value between the first housing 201 and the second housing 202.

The sensor value and the sensor value range described as examples are one example, and may be changed according to various embodiments and applied

In an embodiment, a sensor value acquired through the sensor 276 in the first folding state by the electronic device 200 may be a value of a first range (e.g., 0 to 0.3) and/or a first value (e.g., 0). A sensor value acquired through the sensor 276 in the second folding state by the electronic device 200 may be a value of a second range (e.g., 0.3 to 0.6) and/or a second value (e.g., 0.5). A sensor value acquired through the sensor 276 in the third folding state by the electronic device 200 may be, for example, a value of a third range (e.g., 0.6 to 1) and/or a third value (e.g., 1). In an embodiment, the processor 220 may identify whether the sensor value acquired through the sensor 276 is the value of the first range and/or the first value. When the sensor value acquired through the sensor 276 is the value of the first range and/or the first value, the processor 220 may identify whether the angle value between the first housing 201 and the second housing 202 is in a first angle range (e.g., 180 degrees to 120 degrees). In an embodiment, when the angle value between the first housing 201 and the second housing 202 is in the first angle range (e.g., 180 degrees to 120 degrees), the processor 220 may determine the state of the electronic device 200 to be the first folding state.

In an embodiment, the processor 220 may identify whether the sensor value acquired through the sensor 276 is the value of the second range and/or the second value. When the sensor value acquired through the sensor 276 is the value of the second range and/or the second value, the processor 220 may identify whether the angle value between the first housing 201 and the second housing 202 is in a second angle range (e.g., 120 degrees to 60 degrees). In an embodiment, when the angle value between the first housing 201 and the second housing 202 is in the second angle range (e.g., 120 degrees to 60 degrees), the processor 220 may determine the state of the electronic device 200 to be the second folding state.

The processor 220 may identify whether the sensor value acquired through the sensor 276 is the value of the third range and/or the third value. When the sensor value acquired through the sensor 276 is the value of the third range and/or the third value, the processor 220 may identify whether the angle value between the first housing 201 and the second housing 202 is in a third angle range (e.g., 60 degrees to 0 degrees). In an embodiment, when the angle value between the first housing 201 and the second housing 202 is in the third angle range (e.g., 60 degrees to 0 degrees), the processor 220 may determine the state of the electronic device 200 to be the third folding state. In an embodiment, the processor 220 may identify whether the electronic device 200 is mounted and/or a mounting direction. For example, the processor 220 may identify, based the sensor value acquired through a motion sensor (not shown), whether the electronic device 200 is mounted and/or a mounting direction.

In operation 320, based on the folding state of the electronic device 200, the processor 220 according to various embodiments may determine a display position of the quick panel on the display 260, based on an input position of a quick panel display on the display 260 and/or an input position of a user.

The processor 220 may determine, in response to the electronic device 200 being in the first folding state, the input position of the quick panel display and/or the display position of the quick panel as a first area 261 of the display 260.

The electronic device 200 according to an embodiment may determine, in response to the electronic device 200 being in the second folding state, the input position of the quick panel display as a first area 261 and/or a second area 262 of the display 260.

The electronic device 200 may determine the display position of the quick panel as a first area 261 of the display 260 when the electronic device 200 is in the second folding state and an input of the quick panel display of the user is input to the first area 261.

The electronic device 200 may determine the display position of the quick panel as the second area 262 of the display 260 when the electronic device 200 is in the second folding state and an input of the quick panel display of the user is input to the second area 262.

The electronic device 200 according to an embodiment may not determine information related to the input position of the quick panel display and/or the display position of the quick panel in response to the electronic device 200 being the third folding state.

In operation 330, the processor 220 may determine, based on a running application, a component of the quick panel.

The processor 220 according to an embodiment may identify the running application. For example, the application may include a camera application, a voice call application, a message application, a video call application, a gallery application, an audio application, an Internet application, a video reproduction application, and/or a note application. The applications above are just some examples of the application which can be executed by the electronic device 200, and there may be various running applications.

The processor 220 may determine, based on the running application, components constituting the quick panel.

When there is a running application, the processor 220 may determine to configure, in a quick panel, at least one of a component related to Wi-Fi activation or deactivation, a component related to mobile data activation or deactivation, and a component related to a sound mode, a vibration mode, or a silent mode.

When the running application is a communication-related application (e.g., a voice call, a message, or a video call), the processor 220 may determine to further configure, in the quick panel, at least one of a component related to Bluetooth activation or deactivation, a component related to a sleep mode, and a component related to GPS activation or deactivation.

When the running application is a multimedia viewing-related application (e.g., gallery, video, Internet, or video reproduction), the processor 220 may determine to configure, in the quick panel, a component related to Bluetooth activation or deactivation, a component related to a sleep mode, a component related to screen brightness adjustment, a component related to mirroring, and a component related to easy screen viewing.

When the running application is a content generation-related application (e.g., note), the processor 220 may determine to configure, in the quick panel, a component related to screen recording, a component related to short-distance sharing, a component related to screen brightness adjustment, and a component related to easy screen viewing. The components above are just some examples of the quick panel component configured in the electronic device 200, and the component of the quick panel corresponding to the running application may have various configurations.

In operation 340, the processor 220 according to various embodiments may configure a quick panel and display the same in a designated area of the display 260.

The processor 220 according to an embodiment may display a component of the determined quick panel in the designated area.

The processor 220 according to an embodiment may acquire an input (e.g., a top-down swipe 421) for display of the quick panel from a user in the area determined in operation 320, and display the quick panel determined in operation 330 in the area determined in operation 320 in response to the input.

The processor 220 may display the component of the determined quick panel in the designated area in response to the electronic device 200 being maintained for a designated time interval or longer.

The processor 220 may display, based on whether the electronic device 200 is mounted and/or a mounting direction, the component of the determined quick panel.

The processor 220 according to an embodiment may display a notification in the designated area (e.g., the area determined in operation 320).

When a designated number (e.g., N) or greater of notifications each having designated contents occur, the processor 220 according to an embodiment may display the notification in the designated area.

The notification may be a notification having designated contents. For example, a notification having designated contents related to a call may include incoming from a person to whom a user frequently makes a call, incoming from a person to whom the user recently has made a call, incoming from a number in Favorites, incoming from a number registered in a contact, and a missed call notification. For example, a notification having designated contents related to the application may include a notification provided by a frequently used application, a notification from an SNS to which a person contacted frequently belongs, a notification of the user's acceptance or rejection, and/or a notification related to deposit in or withdrawal from the user's account. In another example, a notification having designated contents related to a schedule may include a configured schedule notification when there is a configured schedule reminder. For example, a notification having designated contents related to configuration may include a battery residual amount notification (e.g., 15% or less).

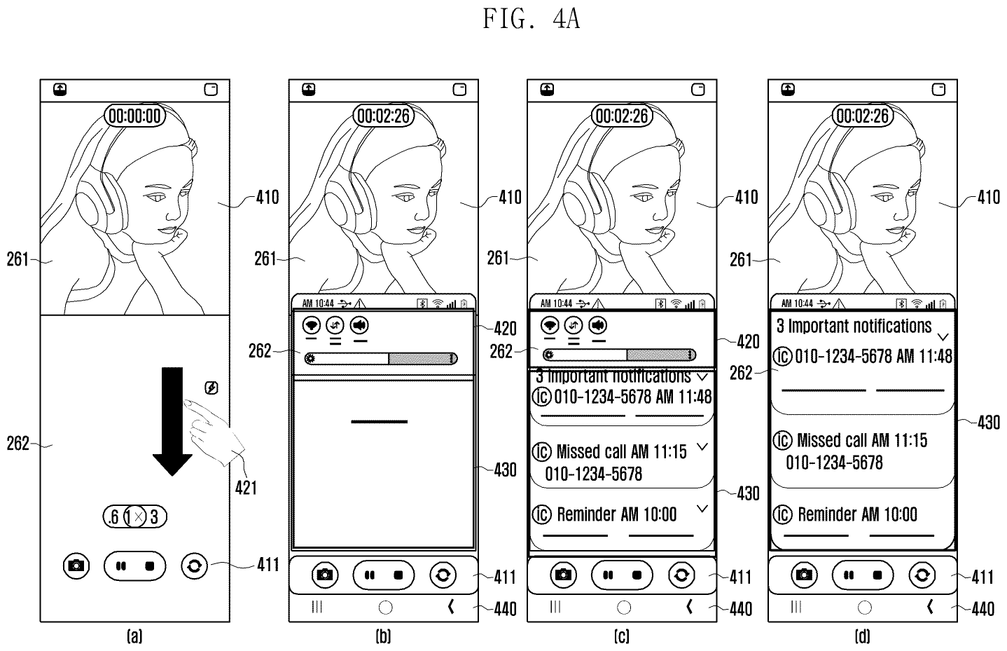

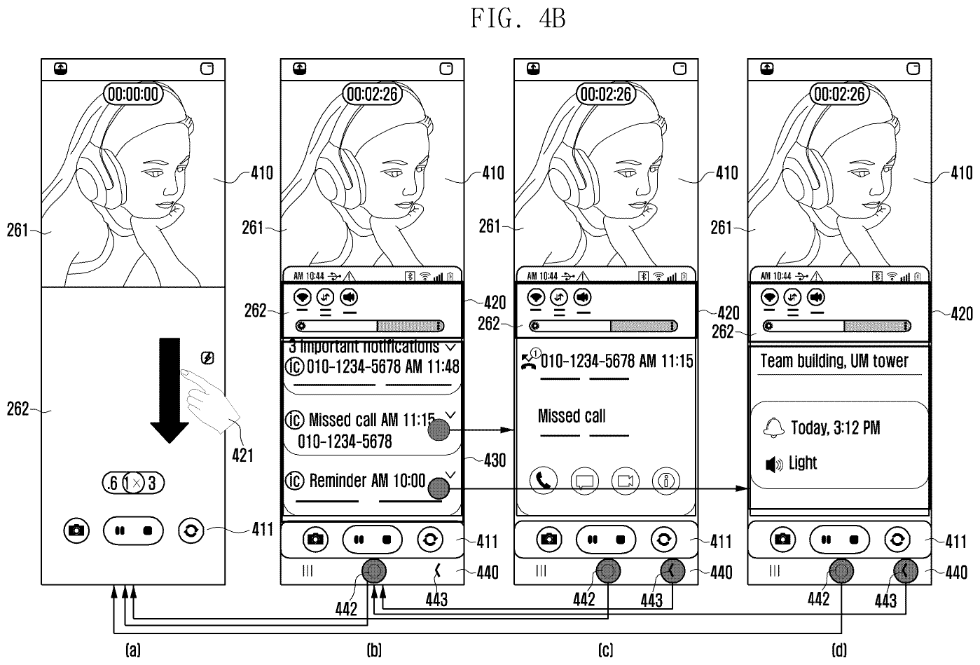

FIG. 4A illustrates an example of a screen configured and displayed by a processor (e.g., the processor 220 of FIG. 2E) in a second folding state of an electronic device (e.g., the electronic device 200 of FIG. 2E) according to an embodiment of the disclosure.

FIG. 4A may be a screen when a running application 410 is a camera-related application

Parts (a) to (d) are examples of screens displayed on the display 260 when the electronic device 200 is in the second folding state.

In an embodiment, the processor 220 may identify, based on whether a sensor value acquired through a sensor (e.g., the sensor 276 of FIG. 2E) is included in a designated value range and whether an angle value between a first housing (e.g., the housing 201 of FIG. 2A) and a second housing (e.g., the second housing 202 of FIG. 2A) is in a designated angle range, a folding state of the electronic device 200.

The folding state of the electronic device 200 according to an embodiment may be divided in to a first folding state, a second folding state, and/or a third folding state. For example, the first folding state may indicate a folding state of the electronic device 200 when the angle value between the first housing 201 and the second housing 202 is in a first angle range (e.g., 180 degrees to 120 degrees). For example, the second folding state may indicate a folding state of the electronic device 200 when the angle value between the first housing 201 and the second housing 202 is in a second angle range (e.g., 120 degrees to 60 degrees). The third folding state may indicate a folding state of the electronic device 200 when the angle value between the first housing 201 and the second housing 202 is in a third angle range (e.g., 60 degrees to 0 degrees). According to an embodiment, the processor 220 may determine an input position of a quick panel display as a first area 261 and/or a second area 262 of the display 260 in response to the state of the electronic device 200 being the second folding state. The electronic device 200 according to an embodiment may determine a display position of a quick panel as the first area 261 of the display 260 when the electronic device is in the second folding state and an input of the quick panel display of the user is received in the first area 261.

The electronic device 200 may determine the display position of the quick panel as the second area 262 of the display 260 when the electronic device 200 is in the second folding state and an input of the quick panel display of the user is received in the second area 262.

Part (a) may be an example of a screen initially displayed on the display 260 when the electronic device 200 is in the second folding state. Referring to part (a), a running application 410 is displayed in the first area 261 of the display 260 and a control icon 411 (e.g., an icon related to image-capturing by a camera) related to the running application 410 (e.g., a camera application) in the second area 262.

The processor 220 according to an embodiment may acquire an input (e.g., a top-down swipe 421) for a quick panel display from the user in the second area 262 and display the quick panel in response to the input.

In an embodiment, the processor 220 may identify whether the electronic device 200 is mounted and/or a mounting direction. For example, the processor 220 may identify, based on a sensor value acquired through a motion sensor (not shown), whether the electronic device 200 is mounted and/or a mounting direction.

The processor 220 may display, based on whether the electronic device 20 is mounted and/or the mounting direction, a component of the determined panel in a designated area.

The processor 220 according to an embodiment may determine a component of the quick panel related to the running application 410 and display the same in a designated area.

For example, in response to the running application 410 being a camera application, the processor 220 may determine the component of the quick panel as Wi-Fi, mobile data, sound/vibration/silent, and/or screen brightness.

The processor 220 may display the component of the quick panel related to the running application 410 in the second area 262.

The processor 220 according to an embodiment may display a notification in the second area 262. For example, when a designated number (e.g., N) or greater notifications each having designated contents occur, the processor 220 may display the notification in the second area 262.

Parts (b) to (d) may be screens configured and displayed by the processor 220 after the electronic device 200 acquires an input (e.g., a top-down swipe 421) for a quick panel display from the user in the second area 262.

Parts (b) to (d) are merely provided as configurations of screens according to an embodiment, and a quick panel area 420, a notification area 430, a control icon 411, and a home button area 440 may be configured in various forms.

Part (b) may be an example of a screen displayed on the display 260 when there is a component of the quick panel related to the running application 410 and there is no important notification.

Referring to part (b), the processor 220 may display components of Wi-Fi, mobile data, sound/vibration/silent, and/or screen brightness in the quick panel area 420, display a message indicating no notification in the notification display area 430, and display the control icon 411 related to the running application 410 and the home button area 440 in the second area 262 of the display 260.

Part (c) may be an example of a screen displayed on the display 260 when there is a component of the quick panel related to the running application 410 and there is a notification having designated contents.

Referring to part (c), the processor 220 may display components of Wi-Fi, mobile data, sound/vibration/silent, and/or screen brightness in the quick panel area 420 in the second area 262 of the display 260, display a notification in the notification display area 430, and display the control icon 411 related to the running application 410 and the home button area 440.

Part (d) may be an example of a screen displayed on the display 260 when there is no component of the quick panel related to the running application 410 and there is an important notification.

Referring to part (d), the processor 220 may display the notification in the notification display area 430 in the second area 262 of the display 260, and display the control icon 411 related to the running application 410 and the home button area 440.

FIG. 4B illustrates an example of a screen configured and displayed by the processor 220 in a second folding state of the electronic device 200 according to an embodiment of the disclosure.

Parts (a) to (d) may be examples of screens displayed on the display 260 when the electronic device 200 is in the second folding state.

Part (a) may be an example of a screen initially displayed on the display 260 when the electronic device 200 is in the second folding state. Referring to part (a), the running application 410 may be displayed in the first area 261 of the display 260, and the control icon 411 related to the running application 410 may be displayed in the second area 262.

Part (b) may be an example of a screen configured and displayed by the processor 220 after the electronic device 200 acquires an input (e.g., a top-down swipe 421) for a quick panel display from the user in the second area 262 in the state of part (a).

Referring to part (b), the processor 220 may display components of Wi-Fi, mobile data, sound/vibration/silent, and/or screen brightness in the quick panel area 420, display a notification in the notification display area, display the control icon 411 related to the running application 410, and display the home button area 440 in the second area 262 of the display 260.

When the user selects the home button icon 442 in part (b), the processor 220 may switch to a screen as in part (a) on the display 260.

Parts (c) and (d) may be screens configured and displayed by the processor 220 after the electronic device 200 acquires an input of selecting one of notifications displayed in the notification 430 from the user in the state of part (b).

Referring to part (c), the processor 220 may configure and display a screen related to a missed call in the notification 430 after the electronic device 200 acquires an input of selecting a missed call notification from the user in the state of part (b).

When the user selects the home button icon 442 in part (c), the processor 220 may switch to a screen as in part (a) on the display 260, and when the user selects a backward icon 443, the processor 220 may switch to a screen as in part (b) on the display 260.

Referring to part (d), the processor 220 may configure and display a screen related to a schedule in a notification area after the electronic device 200 acquires an input of selecting a schedule notification from the user in the state of part (b).

When the user selects the home button icon 442 in part (b), the processor 220 may switch to a screen as in part (a) on the display 260, and when the user selects a backward icon 443, the processor 220 may switch to a screen as in part (b) on the display 260.

In the description related to FIGS. 4A and 4B, it has been described that the electronic 200 acquires the input (e.g., the top-down swipe) for the quick panel display from the user in the second area 262, and determines the display position of the quick panel in the second area 262 of the display 260 to display the quick panel area 420, the notification area 430, the control icon 411, and/or the home button area 440 in the second area 262, but when acquiring the input (e.g., the top-down swipe) for the quick panel display from the user in the first area 261, the processor 220 may determine the input position of the quick panel display and/or the display position of the quick panel in the first area 261 of the display 260 so as to display the quick panel area 420, the notification display area 430, the control icon 411, and/or the home button area 440 in the first area 261.

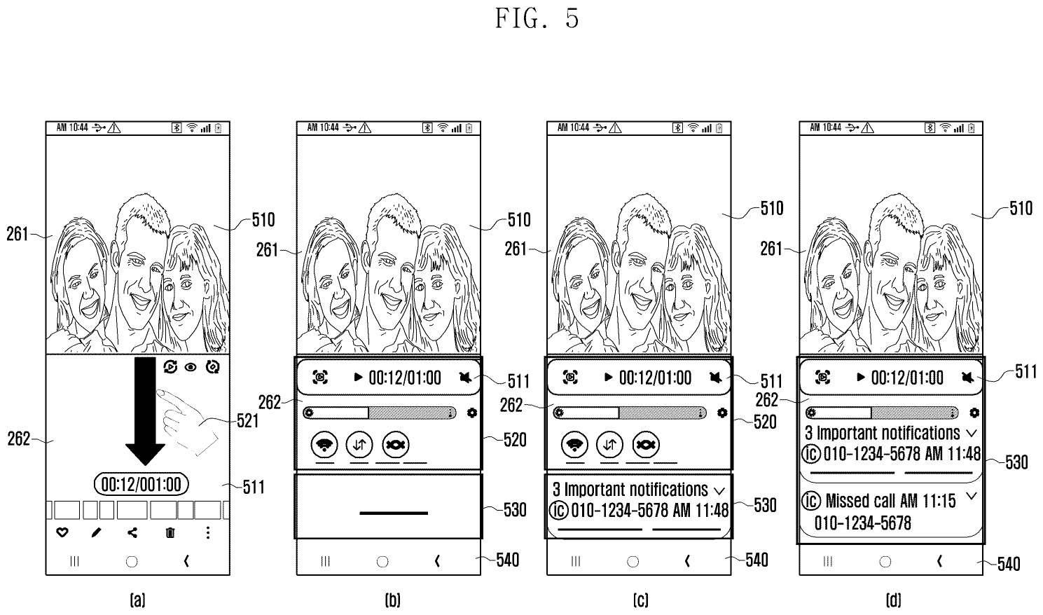

FIG. 5 illustrates an example of a screen configured and displayed by a processor 220 in a second folding state of an electronic device 200 according to an embodiment of the disclosure.

FIG. 5 may be a screen displayed on a display (e.g., the display 260 of FIG. 2E) of an electronic device (e.g., the electronic device 200 of FIG. 2E) when a running application 510 is a gallery-related application.

Parts (a) to (d) may be examples of screens displayed on the display 260 when the electronic device 200 is in the second folding state.

The processor 220 may identify, based on whether a sensor value acquired through the sensor 276 is included in a designated value range and whether an angle value between the first housing 210 and the second housing 202 is in a designated angle range, a folding state of the electronic device 200.

According to an embodiment, the processor 220 may determine an input position of a quick panel display in a first area 261 and/or a second area 262 of the display 260 in response to the state of the electronic device 200 being in the second folding state.

The electronic device 200 may determine the display position of the quick panel in the first area 261 of the display 260 when the electronic device 200 is in the second folding state and the input of the quick panel display of the user is received in the first area 261.

The electronic device 200 according to an embodiment may determine the display position of the quick panel in the second area 262 of the display 260 when the electronic device 200 is in the second folding state and the input of the quick panel display of the user is received in the second area 262.

Part (a) may be an example of a screen initially displayed on the display 260 when the electronic device 200 is in the second folding state. Referring to part (a), a running application 510 may be displayed in the first area 261 of the display 260, and a control icon 511 (e.g., an icon related to execution of a video in a gallery) related to the running application 510 (e.g., a gallery application) may be displayed in the second area 262.

The processor 220 may acquire an input (e.g., a top-down swipe 521) for displaying a quick panel from the user in the second area 262 and display the quick panel in response to the input.

In an embodiment, the processor 220 may identify whether the electronic device is mounted and/or a mounting direction. For example, the processor 220 may identify, based on a sensor value acquired through a motion sensor (not shown), whether the electronic device 200 is mounted and/or a mounting direction.

The processor 220 may display, based on whether the electronic device 200 is mounted and/or the mounting direction, a component of the determined quick panel in a designated area.

The processor 220 according to an embodiment may determine a component of the quick panel related to the running application 510 and display the same in a designated area.

For example, the processor 220 may determine components of the quick panel as Wi-Fi, sound/vibration/silent, short-distance sharing (e.g., nearby share), and/or screen brightness in response to the running application 510 being a gallery application.

The processor 220 according to an embodiment may display a component of the quick panel related to the running application 510 in the second area 262.

The processor 220 may display a notification in the second area 262. For example, when a designated number (e.g., N) or greater number of notifications each having designated contents occur, the processor 220 may display the notifications in the second area 262.

Parts (b) to (d) may be screens configured and displayed by the processor 220 after the electronic device 200 acquires an input (e.g., a top-down swipe 521) for the quick panel display from the user in the second area 262.

Parts (b) to (d) are merely provided as configurations of screens according to an embodiment, and a quick panel area 520, a notification area 530, a control icon 511, and a home button area 540 may be configured in various forms.

Part (b) may be an example of a screen displayed on the display 260 when there is a component of the quick panel related to the application 510 and there is no important notification.

Referring to part (b), the processor 220 may display components of Wi-Fi, sound/vibration/silent, short-distance sharing (e.g., nearby share), and/or screen brightness of the quick panel in the quick panel area 520, display a message indicating no notification in the notification display area 530, and display the control icon 511 related to the running application 510 and the home button area 540 in the second area 262 of the display 260.

Part (c) may be an example of a screen displayed on the display 260 when there is a component of the quick panel related to the running application 510 and there is a notification having designated contents.

Referring to part (c), the processor 220 may display components of Wi-Fi, sound/vibration/silent, short-distance sharing (e.g., nearby share), and/or screen brightness of the quick panel in the quick panel area 520, display a notification in the notification display area 530, and display the control icon 511 related to the running application 510 and the home button area 540 of the quick panel in the second area 262 of the display 260.

Part (d) may be an example of a screen displayed on the display 260 when there is no component of the quick panel related to the running application 510 and there is an important notification.

Referring to part (d), the processor 220 may display a notification in the notification display area 530 and display the control icon 511 related to the running application 510 and the home button area 540 in the second area 262 of the display 260.

In the description with reference to FIG. 5, it has been described that the electronic device 200 acquires an input (e.g., a top-down swipe) for the quick panel display from the user in the second area, and determine a display position of the quick panel as the second area 262 of the display 260, and display the quick panel area 520, the notification display area 530, the control icon 511, and/or the home button area 540 in the second area 262, but when acquiring the input (e.g., the top-down swipe) for the quick panel display from the user in the first area 261, the processor 220 may determine the input position of the quick panel display and/or the display position of the quick panel in the first area 261 of the display 260, and display the quick panel area 520, the notification display area 530, the control icon 511, and/or the home button area 540 in the first area 261.

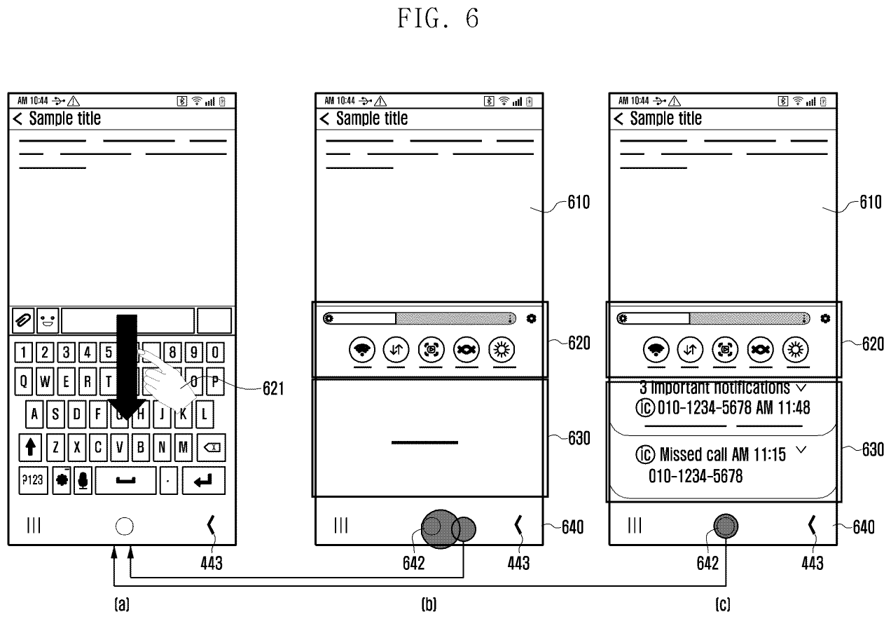

FIG. 6 may be a screen displayed on a display (e.g., the display 260 of FIG. 2E) of an electronic device (e.g., the electronic device 200 of FIG. 2E) when a running application 610 is a memo-related application according to an embodiment of the disclosure.

Parts (a) to (c) may be examples of screens displayed on the display 260 when the electronic device 200 is in a second folding state.

In an embodiment, the processor 220 may identify, based on whether a sensor value acquired through the sensor 276 is included in a designated value range and whether an angle value between a first housing 201 and a second housing 202 is in a designated angle range, a folding state of the electronic device 200.

The processor 220 may determine an input position of a quick panel display in a first area 261 and/or a second area 262 of the display 260 in response to the state of the electronic device 200 being in the second folding state.

The electronic device 200 according to an embodiment, the electronic device 200 may determine a display position of the quick panel as the first area 261 of the display 260 when the electronic device 200 is in the second folding state and an input of the quick panel display of the user is received in the first area 261.

The electronic device 200 may determine the display position of the quick panel as the second area 262 of the display 260 when the electronic device 200 is in the second folding state and the input of the quick panel display of the user is received in the second area 262.

In an embodiment, the processor 220 may identify whether the electronic device 200 is mounted and/or a mounting direction. For example, the processor 220 may identify, based on a sensor value acquired through a motion sensor (not shown), whether the electronic deice 200 is mounted and/or a mounting direction.

The processor 220 according to an embodiment may display, based on whether the electronic device 200 is mounted and/or the mounting direction, a component of the determined quick panel in a designated area.

Part (a) may be an example of a screen initially displayed on the display 260 when the electronic device 200 is in the second folding state. Referring to part (a), a running application 610 may be displayed in the first area 261 of the display 260, and a control icon 611 related to the running application 610 may be displayed in the second area 262.

Part (b) may be an example of a screen displayed on the display 260 when there is a component of the quick panel related to the running application 610 and there is no important notification.

Part (b) may be an example of a screen configured and displayed by the processor 220 after the electronic device 200 acquires an input (e.g., a top-down swipe 621) for the quick panel display from the user in the second area 262 in the state of part (a).

Referring to part (b), the processor 220 may display components of Wi-Fi, mobile data, screen recorder, short-distance sharing (e.g., nearby share), easy screen viewing, and screen brightness adjustment in the quick panel area 620, display a message indicating there is no notification in the notification display area 630, and display the home button area 640 in the second area 262 of the display 260.

When the user selects the home button icon 642 in part (b), the processor 220 may switch to a screen as in part (a) on the display 260 and display the same.

Part (c) may be an example of a screen displayed on the display 260 when there is a component of the quick panel related to the running application 610 and there is a notification having designated contents.

Referring to part (c), the processor 220 may display components of Wi-Fi, mobile data, screen recorder, short-distance sharing (e.g., nearby share), easy screen viewing, and screen brightness adjustment in the quick panel area 620, display a notification in the notification display area 630, and display the home button area 640 in the second area 262 of the display 260.

When the user selects the home button icon 642 in part (c), the processor 220 may switch a screen as in part (a) on the display 260 and display the same.

In the description related to FIG. 6, it has been described that the electronic device 200 acquires an input (e.g., a top-down swipe) for the quick panel display from the user in the second area 262, determines the display position of the quick panel in the second area 262 of the display 260, and displays the quick panel area 620, the notification display area 630, the control icon 611, and/or the home button area 640 in the second area 262, but when acquiring the input (e.g., the top-down swipe) for the quick panel display from the user in the first area 261, the processor 220 may determine the input position of the quick panel display and/or the display position of the quick panel in the first area 261 of the display 260, and display the quick panel area 620, the notification display area 630, the control icon 611, and/or the home button area 640 in the first area 261.

An electronic device according to various embodiments may include a first housing, a second housing which is connected to the first housing so as to be foldable with reference to a designated axis, and changes an overall shape of the electronic device, a sensor configured to detect a folding state of the electronic device, a display including a flexible display which has at least partial area foldable with reference to the designated axis, and is divided into a first area and a second area with reference to the designated axis, and a processor, wherein the processor is configured to detect the folding state of the electronic device by using the sensor, determine, based on the folding state, an area in which an input for displaying a quick panel on the display is to be received and an area in which the quick panel is to be displayed, determine a configuration of the quick panel by determining, based on a running application, a component to be included in the quick panel, and display the quick panel having the determined configuration in the determined area in response to receiving, in the determined area, the input for displaying the quick panel.

With respect to the electronic device according to various embodiments, the folding state of the electronic device is divided into a first folding state in which the electronic device is fully unfolded, a second folding state in which the electronic device is folded in a designated angle range, and a third folding state in which the electronic device is fully folded, and the processor may be configured to, in response to the folding state of the electronic device being a second folding state, determine, as a second area of the display, the area in which the input for displaying the quick panel on the display is to be received and the area in which the quick panel is to be displayed.

With respect to the electronic device according to various embodiments, the processor may be configured to, in response to receiving, in the second area, the input for displaying the quick panel, display a control UI related to the running application and the quick panel in the second area.

With respect to the electronic device according to various embodiments, the processor may be configured to further display a notification in the second area in response to occurrence of the notification.

With respect to the electronic device according to various embodiments, the notification is a notification of designated contents, and the notification of the designated contents may be further displayed in the second area in response to a number of notifications of the designated contents being equal to or greater than a designated number.

With respect to the electronic device according to various embodiments, the component to be included in the quick panel may include at least one of a component related to Wi-Fi activation or deactivation, a component related to mobile data activation or deactivation, and a component related to a sound mode, a vibration mode, or a silent mode.

With respect to the electronic device according to various embodiments, in response to the running application being a call or a message application, the component to be included in the quick panel may further include at least one of a component related to Bluetooth activation or deactivation, a component related to a sleep mode, a component related to screen brightness adjustment, a component related to mirroring, and a component related to easy screen viewing.

With respect to the electronic device according to various embodiments, in response to the running application being an application related to multimedia reproduction, the component to be included in the quick panel may further include at least one of a component related to Bluetooth activation or deactivation, a component related to automatic screen rotation, and a component related to GPS activation or deactivation.

With respect to the electronic device according to various embodiments, in response to the running application being an application related to content generation, the component to be included in the quick panel may further include at least one of a component related to screen recording, a component related to short-distance sharing, a component related to screen brightness adjustment, and a component related to easy screen viewing.

With respect to the electronic device according to various embodiments, in response to the folding state of the electronic device being maintained as a second folding state for a designated time interval or longer, the area in which the input for displaying the quick panel on the display is to be received and the area in which the quick panel is to be displayed may be determined as the second area of the display.

A method for operating an electronic device which includes a flexible display and is foldable may include detecting a folding state of the electronic device by using a sensor, determining, based on the folding state of the electronic device, an area in which an input for displaying a quick panel on the display is to be received and an area in which the quick panel is to be displayed, determining a configuration of the quick panel by determining, based on a running application, a component to be included in the quick panel, and displaying the quick panel having the determined configuration in the determined area in response to receiving, in the determined area, the input for displaying the quick panel

In the method for operating the electronic device according to various embodiments, the folding state of the electronic device may be divided into a first folding state in which the electronic device is fully unfolded, a second folding state in which the electronic device is folded in a designated angle range, and a third folding state in which the electronic device is fully folded, and the method may further include in response to the folding state of the electronic device being the second folding state, determining, as a second area of the display, an area in which an input for displaying the quick panel on the display is to be received and an area in which the quick panel is to be displayed.

The method for operating the electronic device according to various embodiments may further include in response to receiving, in the second area, the input for displaying the quick panel, displaying a control UI related to the running application and the quick panel in the second area.

The method for operating the electronic device according to various embodiments may include further displaying a notification in the second area in response to occurrence of the notification.

In the method for operating the electronic device according to various embodiments, the notification is a notification of designated contents, and the notification of the designated contents may be further displayed in the second area in response to a number of notifications of the designated contents being equal to or greater than a designated number.

In the method for operating the electronic device according to various embodiments, the component to be included in the quick panel may include at least one of at least one of a component related to Wi-Fi activation or deactivation, a component related to mobile data activation or deactivation, and a component related to a sound mode, a vibration mode, or a silent mode.

In the method for operating the electronic device according to various embodiments, in response to the running application being a call or a message application, the component to be included in the quick panel may further include at least one of a component related to Bluetooth activation or deactivation, a component related to a sleep mode, a component related to screen brightness adjustment, a component related to mirroring, and a component related to easy screen viewing.

In the method for operating the electronic device according to various embodiments, in response to the running application being an application related to multimedia reproduction, the component to be included in the quick panel may further include at least one of a component related to Bluetooth activation or deactivation, a component related to automatic screen rotation, and a component related to GPS activation or deactivation.

In the method for operating the electronic device according to various embodiments, in response to the running application being an application related to content generation, the component to be included in the quick panel may further include at least one of a component related to screen recording, a component related to short-distance sharing, a component related to screen brightness adjustment, and a component related to easy screen viewing.

The method for operating the electronic device according to various embodiments may further include in response to the folding state of the electronic device being maintained as a second folding state for a designated time interval or longer, determining, as the second area of the display, the area in which the input for displaying the quick panel on the display is to be received and the area in which the quick panel is to be displayed. The electronic device according to various embodiments of the disclosure may be various forms of devices. The electronic device may include, for example, a portable communication device (e.g., a smartphone), a computer device, a portable multimedia device, a portable medical device, a camera, a wearable device, or home appliances. The electronic device according to embodiments of the disclosure is not limited to the above-described devices.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to other embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first housing;
a second housing which is connected to the first housing so as to be foldable with reference to a designated axis, and changes an overall shape of the electronic device;
a sensor configured to detect a folding state of the electronic device;
a display comprising a flexible display which has at least partial area foldable with reference to the designated axis, and is divided into a first area and a second area with reference to the designated axis;
memory storing one or more computer programs; and
one or more processors communicatively coupled to the memory,
wherein the one or more computer programs include computer-executable instructions that, when executed by the one or more processors individually or collectively, cause the electronic device to:
detect the folding state of the electronic device by using the sensor,
determine, based on the folding state, an area in which an input for displaying a quick panel on the display is to be received and an area in which the quick panel is to be displayed,
determine a configuration of the quick panel by determining, based on a running application, a component to be included in the quick panel, and
display the quick panel having the determined configuration in the determined area in response to receiving, in the determined area, the input for displaying the quick panel.

2. The electronic device of claim 1,
wherein the folding state of the electronic device is divided into a first folding state in which the electronic device is fully unfolded, a second folding state in which the electronic device is folded in a designated angle range, and a third folding state in which the electronic device is fully folded, and
wherein the one or more computer programs further include computer-executable instructions that, when executed by the one or more processors individually or collectively, cause the electronic device to, in response to the folding state of the electronic device being a second folding state, determine, as a second area of the display, the area in which the input for displaying the quick panel on the display is to be received and the area in which the quick panel is to be displayed.

3. The electronic device of claim 2, wherein the one or more computer programs further include computer-executable instructions that, when executed by the one or more processors individually or collectively, cause the electronic device to, in response to receiving, in the second area, the input for displaying the quick panel, display a control user interface (UI) related to the running application and the quick panel in the second area.

4. The electronic device of claim 3, wherein the one or more computer programs further include computer-executable instructions that, when executed by the one or more processors individually or collectively, cause the electronic device to further display a notification in the second area in response to occurrence of the notification.

5. The electronic device of claim 4,
wherein the notification is a notification of designated contents, and
wherein the one or more computer programs further include computer-executable instructions that, when executed by the one or more processors individually or collectively, cause the electronic device to further display notification of the designated contents in the second area in response to a number of notifications of the designated contents being equal to or greater than a designated number.

6. The electronic device of claim 1, wherein the component to be included in the quick panel comprises at least one of a component related to Wi-Fi activation or deactivation, a component related to mobile data activation or deactivation, and a component related to a sound mode, a vibration mode, or a silent mode.

7. The electronic device of claim 6, wherein in response to the running application being a call or a message application, the component to be included in the quick panel further comprises at least one of a component related to Bluetooth activation or deactivation, a component related to a sleep mode, a component related to screen brightness adjustment, a component related to mirroring, and a component related to easy screen viewing.

8. The electronic device of claim 6, wherein in response to the running application being an application related to multimedia reproduction, the component to be included in the quick panel further comprises at least one of a component related to Bluetooth activation or deactivation, a component related to automatic screen rotation, and a component related to global positioning system (GPS) activation or deactivation.

9. The electronic device of claim 6, wherein in response to the running application being an application related to content generation, the component to be included in the quick panel further comprises at least one of a component related to screen recording, a component related to short-distance sharing, a component related to screen brightness adjustment, and a component related to easy screen viewing.

10. The electronic device of claim 2, wherein the one or more computer programs further include computer-executable instructions that, when executed by the one or more processors individually or collectively, cause the electronic device to, in response to the folding state of the electronic device being maintained as a second folding state for a designated time interval or longer, determine the area in which the input for displaying the quick panel on the display is to be received and the area in which the quick panel is to be displayed, as the second area of the display.

11. A method for operating an electronic device which comprises a flexible display and is foldable, the method comprising:
detecting a folding state of the electronic device by using a sensor;
determining, based on the folding state of the electronic device, an area in which an input for displaying a quick panel on the display is to be received and an area in which the quick panel is to be displayed;
determining a configuration of the quick panel by determining, based on a running application, a component to be included in the quick panel; and
displaying the quick panel having the determined configuration in the determined area in response to receiving, in the determined area, the input for displaying the quick panel.

12. The method of claim 11, further comprising:
in response to the folding state of the electronic device being a second folding state, determining, as a second area of the display, an area in which an input for displaying the quick panel on the display is to be received and an area in which the quick panel is to be displayed,
wherein the folding state of the electronic device is divided into a first folding state in which the electronic device is fully unfolded, the second folding state in which the electronic device is folded in a designated angle range, and a third folding state in which the electronic device is fully folded.

13. The method of claim 12, further comprising:
in response to receiving, in the second area, the input for displaying the quick panel, displaying a control user interface (UI) related to the running application and the quick panel in the second area.

14. The method of claim 13, further comprising:
displaying a notification in the second area in response to occurrence of the notification.

15. The method of claim 12, further comprising:
in response to the folding state of the electronic device being maintained as the second folding state for a designated time interval or longer, determining, as the second area of the display, the area in which the input for displaying the quick panel on the display is to be received and the area in which the quick panel is to be displayed.

16. The method of claim 11, wherein the component to be included in the quick panel comprises at least one of a component related to Wi-Fi activation or deactivation, a component related to mobile data activation or deactivation, and a component related to a sound mode, a vibration mode, or a silent mode.

17. The method of claim 11, wherein in response to the running application being a call or a message application, the component to be included in the quick panel further comprises at least one of a component related to Bluetooth activation or deactivation, a component related to a sleep mode, a component related to screen brightness adjustment, a component related to mirroring, and a component related to easy screen viewing.

18. The method of claim 11, wherein in response to the running application being an application related to multimedia reproduction, the component to be included in the quick panel further comprises at least one of a component related to Bluetooth activation or deactivation, a component related to automatic screen rotation, and a component related to global positioning system (GPS) activation or deactivation.

19. One or more non-transitory computer-readable storage media storing one or more computer programs including computer-executable instructions that, when executed by one or more processors of an electronic device individually or collectively, cause the electronic device to perform operations, the operations comprising:
detecting a folding state of the electronic device by using a sensor;
determining, based on the folding state of the electronic device, an area in which an input for displaying a quick panel on the display is to be received and an area in which the quick panel is to be displayed;
determining a configuration of the quick panel by determining, based on a running application, a component to be included in the quick panel; and
displaying the quick panel having the determined configuration in the determined area in response to receiving, in the determined area, the input for displaying the quick panel.

20. The one or more non-transitory computer-readable storage media of claim 19, the operations further comprising:
in response to the folding state of the electronic device being a second folding state, determining, as a second area of the display, an area in which an input for displaying the quick panel on the display is to be received and an area in which the quick panel is to be displayed,
wherein the folding state of the electronic device is divided into a first folding state in which the electronic device is fully unfolded, the second folding state in which the electronic device is folded in a designated angle range, and a third folding state in which the electronic device is fully folded.
